(19) United States
(12) Patent Application Publication
(10) Pub. No.: US 2008/0107077 A1
(43) Pub. Date: May 8, 2008

(54) Subnet mobility supporting wireless handoff

(76) Inventor: James Murphy, Pleasanton, CA (US)

Correspondence Address: PERKINS COIE LLP, P.O. BOX 2168, MENLO PARK, CA, 94026, US

(21) Appl. No.: 11/592,891

(22) Filed: Nov. 3, 2006

(51) Int. Cl. H04Q 7/00

(52) U.S. Cl. 370/331

(57) ABSTRACT

A handoff technique involves receiving communications in a format associated with a first radio technology, translating the communications to a format associated with a second radio technology, and tunneling the communications from a mobile device to a switch that hosts a virtual LAN (VLAN) associated with the mobile device, and which uses the second radio technology. A system according to the technique may include a first switch, associated with a first access technology; an access point (AP) coupled to the first switch; a second switch, associated with a second access technology, hosting a VLAN; and a user database, including a user profile that is associated with the VLAN, coupled to the second switch.

### BACKGROUND

Wireless systems built today handle mobility by essentially keeping a mobile device on a particular subnet. The mobile device maintains subnet connectivity, practically wherever it moves. Wireless clients may use protocols such as cellular 3TPP, 802.11, 802.16, G3, or other known or convenient protocols.

VLAN tunneling enables tunneling from a remote wireless switch to a local wireless switch. This technology is used in the 802.11 context to allow stations to be placed into their assigned subnet regardless of the wireless switch to which they have associated.

Handing off mobile stations typically involves reassigning an IP address or using some mobile IP technology. These mechanisms have limitations in that the station is aware of the change in address which can result in dropping connections. This is particularly important in the case of voice over IP handoff between heterogeneous networks.

These are but a subset of the problems and issues associated with wireless handoff, and are intended to characterize weaknesses in the prior art by way of example. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A handoff technique involves receiving communications in a format associated with a first radio technology, translating the communications to a format associated with a second radio technology, and tunneling the communications from a mobile device to a switch that hosts a virtual LAN (VLAN) associated with the mobile device, and which uses the second radio technology. A system according to the technique may include a first switch, associated with a first access technology, an access point (AP) coupled to the first switch, a second switch, associated with a second access technology, hosting a VLAN, and a user database, including a user profile that is associated with the VLAN, coupled to the second switch. A method according to the technique may include associating a mobile station with a first switch at a first point of attachment using a first radio technology, assigning a mobile station to a VLAN, providing a Layer 3 identity for the mobile station, associating the mobile station with a second switch at a second point of attachment using a second radio technology, detecting the VLAN assignment, and enabling the mobile station to continue to use the Layer 3 identity without disruption.

The proposed system can offer, among other advantages, subnet mobility supporting heterogeneous wireless handoff. This and other advantages of the techniques described herein will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIGS. 1A, 1B, and 1C depict a system including multiple VLANs.

FIG. 2 depicts a system that includes a 3G environment and an 802.11 environment.

FIGS. 3A and 3B depict a system that includes a voice gateway.

FIG. 4 depicts an example of a switch.

FIG. 5 depicts a flowchart of an example of a method for maintaining Layer 3 applications during wireless handoff.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

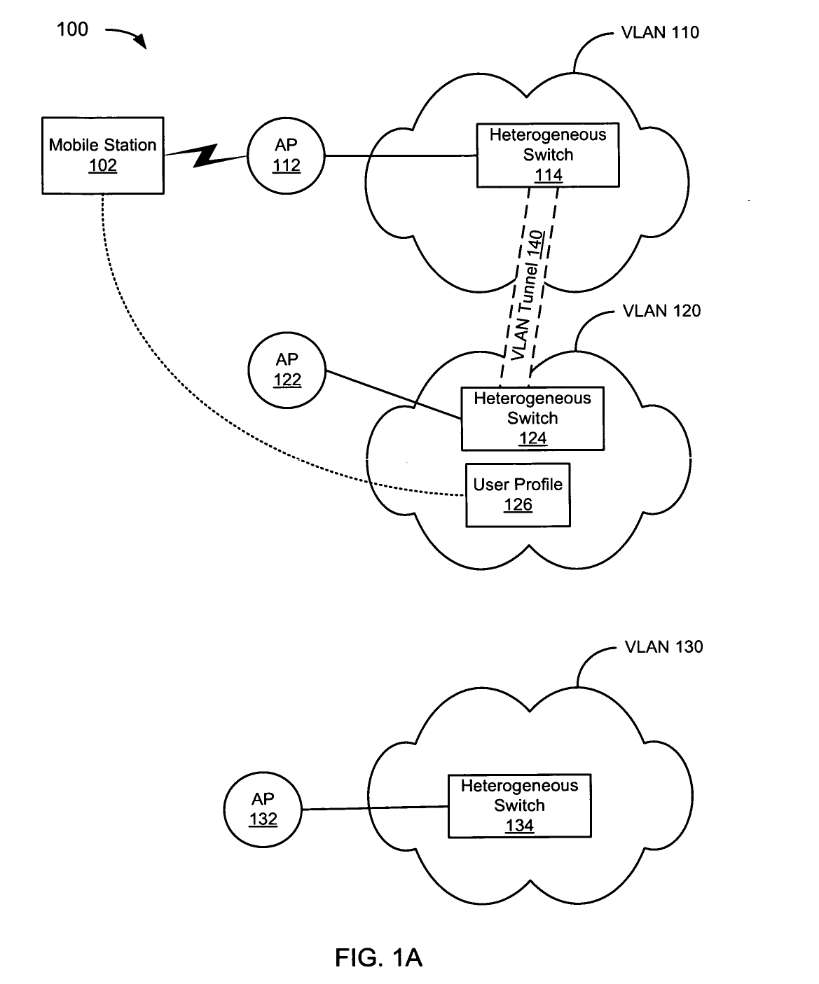

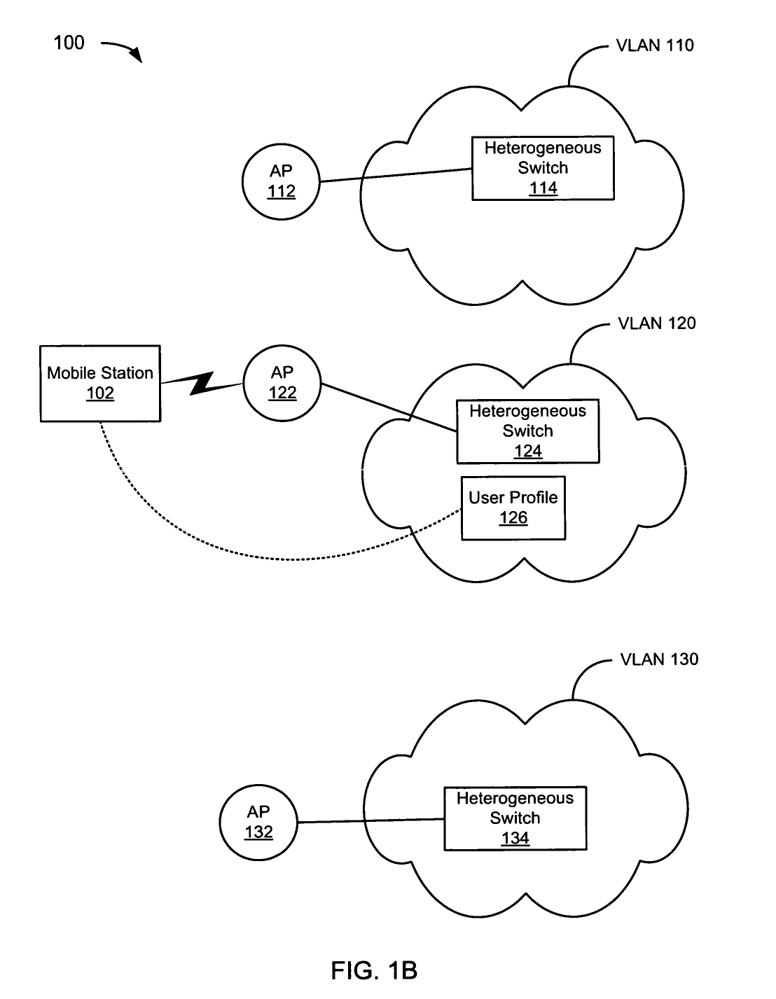

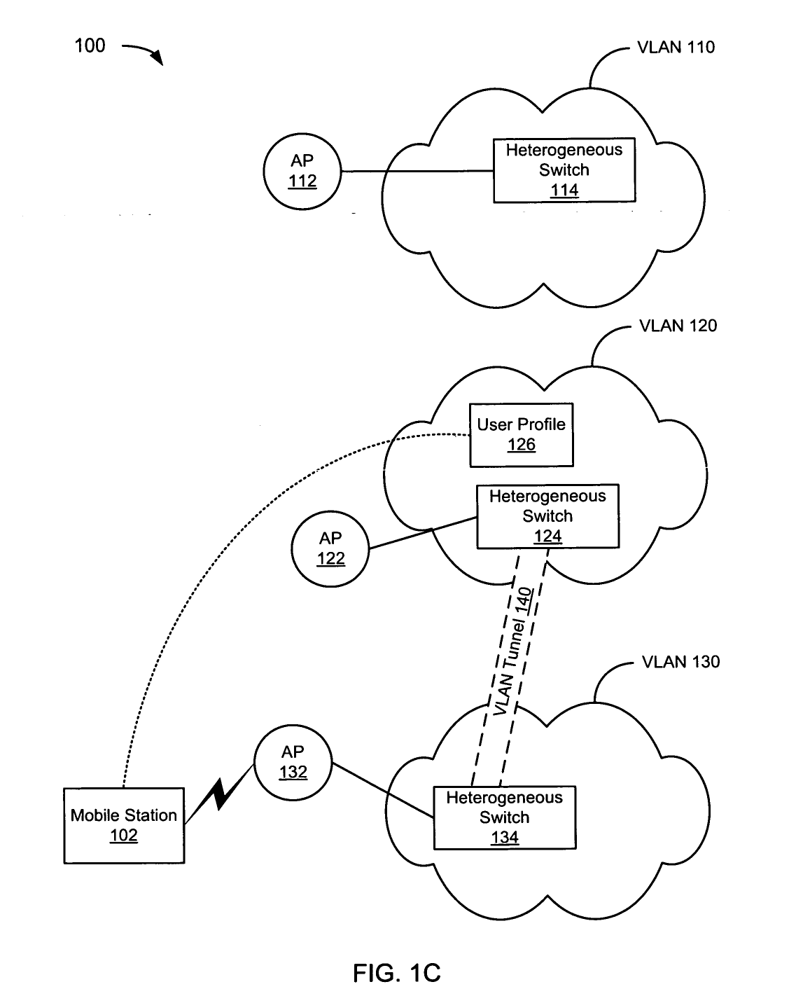

FIG. 1A depicts a system 100 including multiple VLANs. In the example of FIG. 1A, the system 100 includes a mobile station, 102, access points (APs) 112, 122, 132, heterogeneous switches 114, 124, 134, and a user profile 126. These are physical components of the system (the user profile 126 is presumably stored in primary and/or secondary memory). The system 100 also includes some virtual components, which are depicted as clouds in the example of FIG. 1A. Specifically, the system 100 includes VLANs 110, 120, 130. For illustrative purposes, the heterogeneous switch 114 is “in” the VLAN 110, the heterogeneous switch 124 and the user profile 126 are “in” the VLAN 120, and the heterogeneous switch 134 is “in” the VLAN 130. It should be noted that a single heterogeneous switch could be associated (and, therefore, “in”) multiple VLANs and multiple heterogeneous switches could be associated with a single VLAN (neither of which are depicted in the example of FIG. 1A).

The mobile station 102 may be practically any known or convenient device that is capable of communicating with a wireless network, such as, by way of example but not limitation, a pda, cell phone, or laptop. A station, as used herein, may be referred to as a device with a media access control (MAC) address and a physical layer (PHY) interface to the wireless medium that comply with the IEEE 802.11 standard, or some other known or convenient standard. As such, a wireless client may typically be implemented as station. Similarly, in a non-limiting embodiment, the access points 112, 122, 132 are stations.

In the example of FIG. 1A, the APs 112, 122, 132 are capable of wirelessly coupling the mobile station 102, respectively, to the heterogeneous switches 114, 124, 134. The APs 112, 122, 132 may include any known or convenient device that is capable of coupling a wireless station to a heterogeneous switch, including, for example, devices that are wirelessly connected to a heterogeneous switch, and devices that are part of a heterogeneous switch for communicating directly with wireless stations.

In a non-limiting embodiment, the APs 112, 122, 132 are hardware units that act as a communication hub by linking wireless mobile 802.11 stations such as PCs to a wired backbone network. In an embodiment, the APs 112, 122, 132 connect users to other users within the network and, in another embodiment, can serve as the point of interconnection between a WLAN and a fixed wire network. The number of users and size of a network help to determine how many APs are desirable for a given implementation. An implementation of an AP, provided by way of example but not limitation, includes a Trapeze Networks Mobility System™ Mobility Point™ (MP™) AP.

The APs 112, 122, 132 are stations that transmit and receive data (and may therefore be referred to as transceivers) using one or more radio transmitters. For example, an AP may have two associated radios, one which is configured for IEEE 802.11a standard transmissions, and the other which is configured for IEEE 802.11b standard transmissions. In a non-limiting embodiment, an AP transmits and receives information as radio frequency (RF) signals to and from the mobile station 102 over a radio interface using a radio technology (e.g., not necessarily 802.11). In another embodiment, signals are transmitted to the switches 113, 124, 134 via a 10/00BASE-T Ethernet connection. The APs 112, 122, 132 transmit and receive information to and from their associated heterogeneous switches 114, 124, 134. Connection to a second heterogeneous switch provides redundancy.

The heterogeneous switches 114, 124, 134 are configured as members of respective VLANs 110, 120, 130. The heterogeneous switches 114, 124, 134 are responsible for assigning users to VLANs as users associate with the heterogeneous switch.

The heterogeneous switches 114, 124, 134 are capable of providing a Layer 2 path for Layer 3 traffic, preserving IP addresses, sessions, and other wired Layer 3 attributes. In the example of FIG. 1A, a VLAN tunnel 140 has been established between the heterogeneous switch 114 and the heterogeneous switch 124. Thus, communications between the heterogeneous switch 124 and the mobile station 102, which has associated with the AP 112 wire coupled to the heterogeneous switch 114, are Layer 3 traffic tunneled through Layer 2. Advantageously, by tunneling Layer 3 traffic at Layer 2, users stay connected with the same IP address and keep the same security and Quality of Service (QoS) policies from the wired network while they roam the wireless side. Since Layer 3 attributes are maintained, mobile stations that are connected to the wireless network can retain persistent identities.

The seven layers of the Open System Interconnection (OSI) model, of which Layers 2 and 3 are a part, are well-known to those of skill in the relevant art, and are, therefore, not described herein in any substantial detail. It should be noted, however, that Layer 3 is known as the “Network Layer” because it provides switching and routing technologies, creating logical paths, known as virtual circuits, for transmitting data from node to node. Routing and forwarding are functions of this layer, as well as addressing, internetworking, error handling, congestion control and packet sequencing. Layer 2 is known as the “Data Link Layer” because at Layer 2 data packets are encoded and decoded into bits; and Layer 2 furnishes transmission protocol knowledge and management and handles errors in the physical layer, flow control and frame synchronization. The data link layer is divided into two sublayers: The Media Access Control (MAC) layer and the Logical Link Control (LLC) layer. The MAC sublayer controls how a computer on the network gains access to the data and permission to transmit it. The LLC layer controls frame synchronization, flow control, and error checking.

In an embodiment, the heterogeneous switches 114, 124,134 swap topology data and client information that details each user's identity, location, authentication state, VLAN membership, permissions, roaming history, bandwidth consumption, and/or other attributes assigned by, by way of example but not limitation, an Authentication, Authorization, and Accounting (AAA) backend (not shown). In an embodiment, the heterogeneous switches 114, 124, 134 provide forwarding, queuing, tunneling, and/or some security services for the information the heterogeneous switches 114, 124, 134 receive from their associated access points 112, 122, 132. In another embodiment, the heterogeneous switches 114, 124, 134 coordinate, provide power to, and/or manage the configuration of the associated APs 112, 122, 132.

In the example of FIG. 1A, in operation, the mobile station 102, associates with the AP 112. The AP 112 attempts to identify a user associated with the mobile station 102. (For illustrative purposes, the user of the mobile station 102 is associated with the user profile 126, which is on VLAN 120.) The heterogeneous switch 114, which is coupled to the AP 112, knows or somehow determines that the user profile 126 is on the VLAN 120. So, the heterogeneous switch 114 requests that the VLAN tunnel 140 be created to the heterogeneous switch 124, which is in VLAN 120. In this way, the user profile 126 becomes properly associated with the mobile station 102, and the associated user can be referred to as being on VLAN 120, even though the user is wirelessly coupled to the AP 112, which is wire coupled to the heterogeneous switch 114, which is on VLAN 110.

The VLANs 110, 120, 130, are considered to be remote with respect to one another. For the purpose of this description, a VLAN is considered to be remote if a switch is not on the VLAN. It follows that if a switch is on a VLAN, then that VLAN is local with respect to the switch. It should be noted that, in the example of FIGS. 1A, 1B, and 1C, the dashed line connecting the user profile 126 to the mobile station 102 is intended to illustrate the association of the relevant user with the mobile stations 102; the dashed line is not intended to illustrate an actual connection, wired or wireless. The user profile 126 is always considered to be local with respect to the second VLAN because the user associated with the user profile 126. However, in a non-limiting embodiment, the user profile 126 could be stored in a database that is remote with respect to the heterogeneous switch 124.

FIG. 1B depicts the system 100 (FIG. 1A) after the mobile station 102 has roamed. When the mobile station 102 associates with the heterogeneous switch 124 (through the AP 122), the user profile 126 continues to be associated with the mobile station 102, and the mobile station 102 does not change VLAN assignment. For this reason, the mobile station 102 need not have a new IP address assigned (or any other equivalent action taken). Advantageously, existing IP connections between the mobile station 102 and other IP hosts, if any, may continue without interruption.

FIG. 1C depicts the system 100 (FIG. 1B) after the mobile station 102 has roamed again (from heterogeneous switch 124 to heterogeneous switch 134). When the mobile station 102 roams from the heterogeneous switch 124 to the heterogeneous switch 134, the heterogeneous switch 134 recognizes that the mobile station 102 is a member of VLAN 120. The heterogeneous switch 134 requests the VLAN tunnel 142 be created between the heterogeneous switch 124 and the heterogeneous switch 134. Since the mobile station 102 has not changed its VLAN assignment, the user is still in VLAN 120, and not be assigned a new IP address. Any existing IP connections between the mobile station 102 and other IP hosts continue to exist uninterrupted.

It should be noted that, in the example of FIGS. 1A to 1C, one or more of the switches may or may not be heterogeneous. It is assumed for the purpose of illustrating a technique described herein that at least one of the switches is heterogeneous. That is, at least one of the switches is capable of handling the conversion of a first radio technology into a second radio technology.

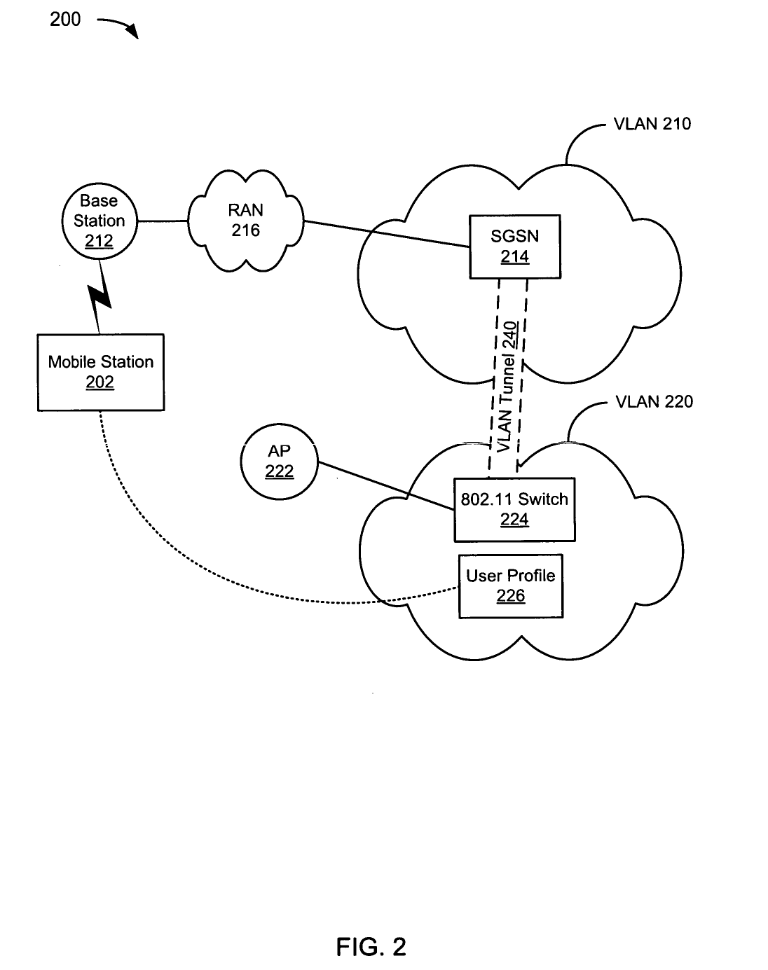

FIG. 2 depicts a system 200 that includes a 3G environment and an 802.11 environment. In the example of FIG. 2, the system 200 includes a mobile station 202, base station 212, AP 222, a serving GPRS support node (SGSN) 214, a radio access network (RAN) 216, an 802.11 switch 224, and a user profile 226. The SGSN 214 is “in” the VLAN 210 and the 802.11 switch 224 and the user profile 226 are “in” the VLAN 220. Advantageously, techniques described herein can be used to tunnel between a 3G environment (associated with the SGSN 214) and an 802.11 environment (associated with the 802.11 switch 224). In fact, the technology could be used to support roaming between arbitrary access technologies.

In the example of FIG. 2, a processing element in the forwarding processor of the SGSN 214 is configured to convert a non-802.11 frame such as, by way of example but not limitation, an 802.16 or a GTP frame, into an 802.3 frame. In an embodiment, there is a tunnel from the base station 212 to the SGSN 214. The SGSN 214 de-encapsulates the GTP tunnel header and adds an 802.3 header, then tunnels this 802.3 frame back to the 802.11 switch 224 (i.e., the switch hosting the user's VLAN).

In an embodiment, the MAC address of the mobile station 202 may be used in the 802.3 encapsulation. In such an embodiment, the MAC address must be available regardless of how the mobile station 202 associates (e.g., 3G, 802.11, 802.16, etc.) and serves as a unique identifier for the mobile station 202.

It should be noted that SGSN technology does not refer to an access point as an “AP.” However, all wireless access technologies require something comparable (i.e., a node at which wireless communications are received and/or transmitted). Accordingly, except with reference to FIG. 2, AP is considered to be generally applicable to any technology, regardless of actual verbiage used to describe a device with equivalent functionality.

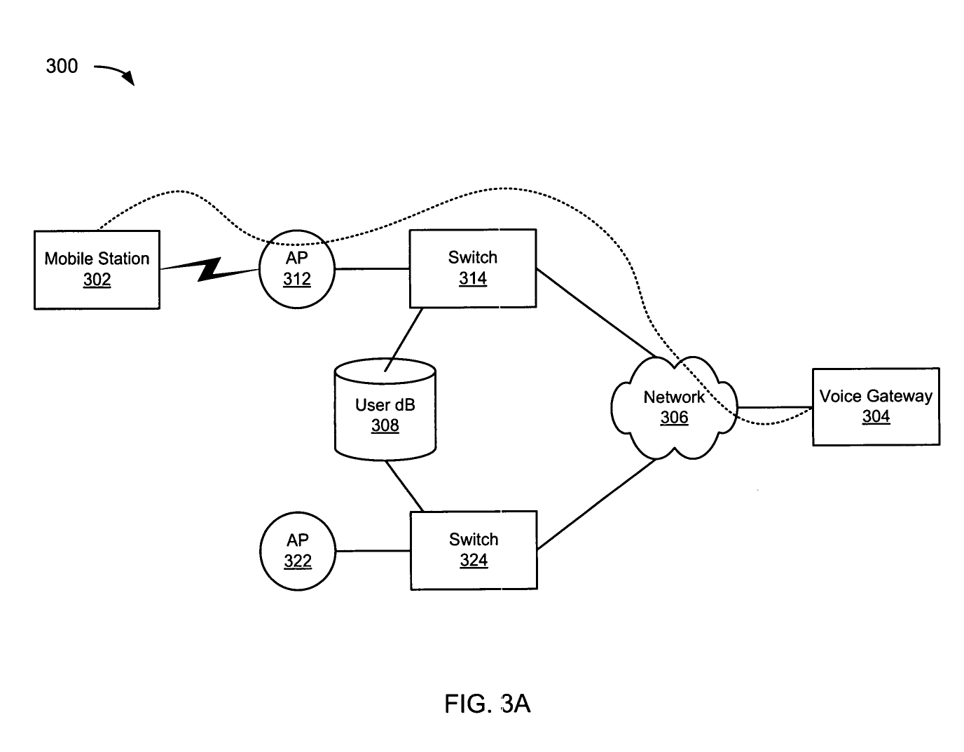

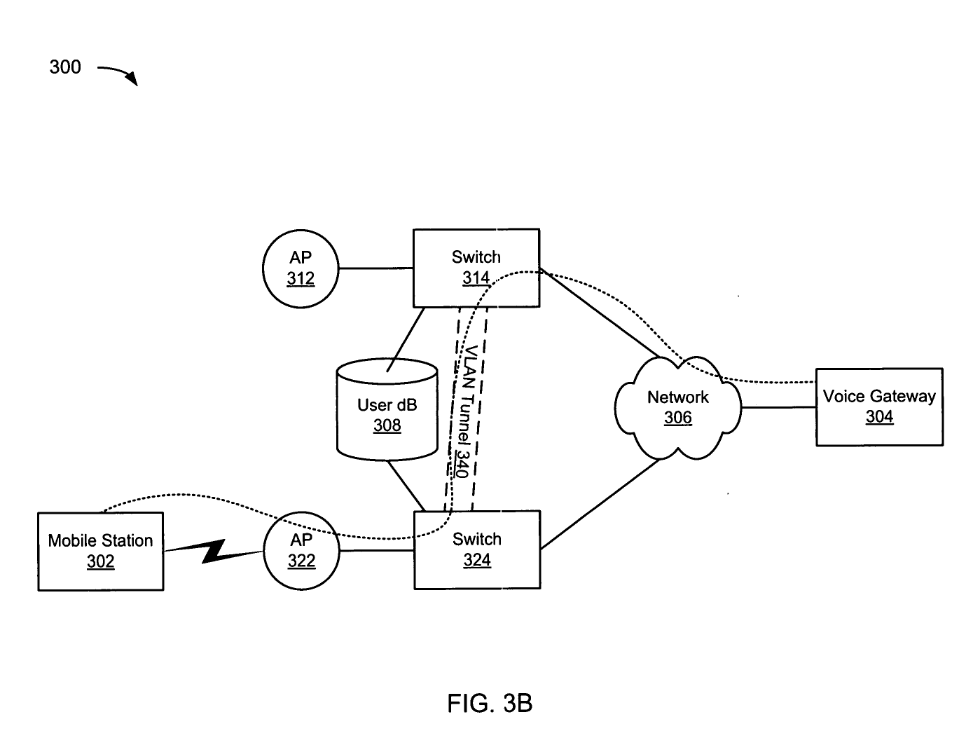

FIGS. 3A and 3B depict a system 300 that includes a voice gateway. In the example of FIG. 3A, the system 300 includes a mobile station 302, a voice gateway 304, a network 306, a user database 308, APs 312, 322, and switches 314, 324. The mobile station 302 is coupled to the voice gateway 304 through the AP 312, the switch 314, and the network 306. The network 306 may be any known or convenient network such as, for example, an IP network. The user database 308 may or may not be a distributed database, and may or may not be stored, in whole or in part, on the switch 314 and/or the switch 324. The user database 308 includes data sufficient to enable the switches 314, 324 to determine to which VLAN the mobile station 302 belongs (and, accordingly, to which of the switches 314, 324 to tunnel traffic, if necessary).

One benefit of subnet mobility is that an IP address for the mobile station 302 need not be changed. So there is no Layer 3 or no IP level change that the mobile station 302 needs to be aware of, facilitating maintenances of existing network connections. This may be most significant in applications where even a very short break can cause annoyance, such as in voice over IP (VoIP) applications. Advantageously, the system 300 enables hiding all the protocol needed to maintain a VoIP connection below the IP layer (Layer 3).

In the example of FIG. 3B, a VLAN tunnel 340 is established between the switch 314 and the switch 324. Using this technique, the VoIP connection is maintained through the VLAN tunnel as illustrated by the dotted line in the example of FIG. 3B. Thus, the voice traffic, rather than being directed to a station coupled to the switch 314, is carried virtually to the mobile station 302 through the VLAN tunnel 340.

Advantageously, the switch 314 and the switch 314 could be associated with different types of wireless. For example, the switch 314 may be an 802.11 switch and the switch 324 may be a 802.16 switch (or 3GPP or some other known or convenient radio technology device).

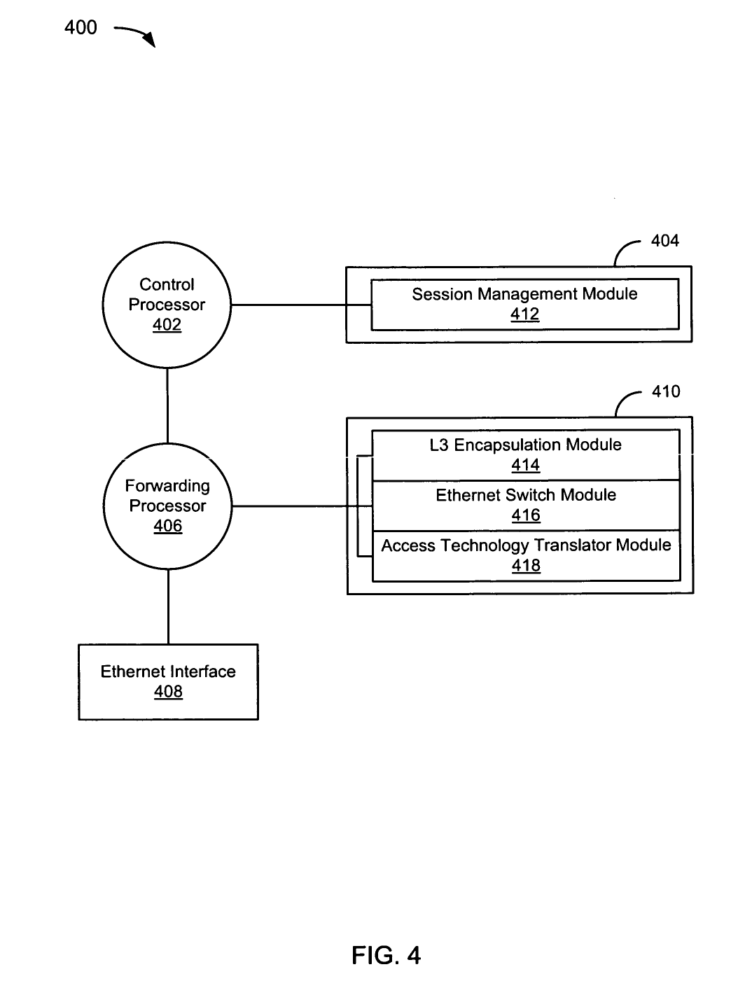

FIG. 4 depicts an example of a switch 400. In the example of FIG. 4, the switch 400 includes a control processor 402, memory 404, a forwarding processor 406, an Ethernet interface 408, and memory 410. The memory 404, which is coupled to the control processor 402, includes a session management module 412. The memory 410, which is coupled to the forwarding processor 406, includes a Layer 3 encapsulation module 414, an Ethernet switch module 416, and an access technology translator module 418.

In the example of FIG. 4, in operation, the session management module 412 receives indication that a station has roamed to it. The session management module 412 determines the VLAN a user associated with the station is on. If the switch 400 is in the user's VLAN, then the switch 400 can handle traffic from the station without assigning new Layer 3 parameters, such as an IP address. However, if the switch 400 is not in the user's VLAN, then the control processor 402 informs the forwarding processor 406 that a VLAN tunnel is needed. The Layer 3 encapsulation module 414 determines the current Layer 3 parameters associated with the station and appropriately encapsulates data. The Ethernet switch module 416 sends the Layer 3 traffic between the station and the switch that is in the user's VLAN. Advantageously, the station can maintain connections using the same Layer 3 parameters it had before the VLAN tunnel was created between the switch 400 and the switch that is in the user's VLAN.

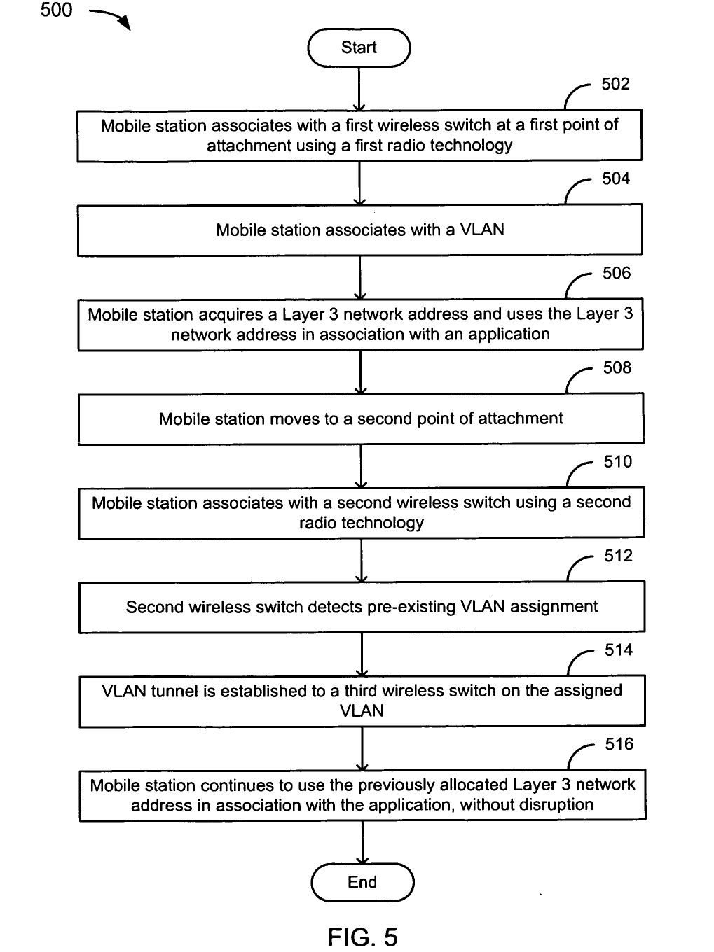

Advantageously, the access technology of the switch and the switch hosting the user's VLAN need not be the same. Specifically, the access technology translator module 418 can translate a first frame of a first radio technology into a second frame of a second radio technology. The access technology translator module 418 can then inject the second frame into the Layer 3 encapsulation module 414 and the Ethernet switch module 416 for VLAN tunneling to the switch hosting the remote VLAN. For example, a GGSN, 802.16, et al. frame could be translated into an 802.3 frame. In this example, the access technology translator module 418 would serve as a “wireless access technology to 802.3 protocol translator.” The access technology translator module 418 may be configured to translate from any known or convenient access technology to any other known or convenient access technology. 0401 FIG. 5 depicts a flowchart 500 of an example of a method for maintaining Layer 3 applications during wireless handoff. This method and other methods are depicted as serially arranged modules. However, modules of the methods may be reordered, or arranged for parallel execution as appropriate. In the example of FIG. 5, the flowchart 500 starts at module 502 where a mobile station associates with a first wireless switch at a first point of attachment using a first radio technology.

In the example of FIG. 5, the flowchart 500 continues to module 504 where the mobile station associates with a VLAN. In an embodiment, the VLAN assignment is accomplished using a distributed database to which all members have access. This facilitates queries to determine whether a VLAN assignment has been made.

In the example of FIG. 5, the flowchart 500 continues to module 506 where the mobile station acquires a Layer 3 network address and begins using the Layer 3 network address in association with an application. A Layer 3 network address may be, for example, an IP address.

In the example of FIG. 5, flowchart 500 continues to module 508 where the mobile station moves to a second point of attachment. This is presumably due to roaming. In the example of FIG. 5, the flowchart 500 continues to module 510 where the mobile station associates with a second wireless switch using a second radio technology. The first and second radio technologies could be the same (e.g., 802.11) in a trivial case.

In the example of FIG. 5, the flowchart 500 continues to module 512 where the second wireless switch detects a pre-existing VLAN assignment. In an embodiment, this detection may be accomplished using a query to a VLAN assignment database.

In the example of FIG. 5, the flowchart 500 continues to module 514 where a VLAN tunnel is established to a third wireless switch on the assigned VLAN. The third wireless switch may be the first wireless switch in a trivial case. Alternatively, the third wireless switch could be some other wireless switch on the assigned VLAN. In the example of FIG. 5, the flowchart 500 continues to module 516 where the mobile station continues to use the previously allocated Layer 3 network address in association with the application, without disruption.

As used herein, a wireless network refers to any type of wireless network, including but not limited to a structured network or an ad hoc network. Data on a wireless network is often encrypted. However, data may also be sent in the clear, if desired. With encrypted data, a rogue device will have a difficult time learning any information (such as passwords, etc.) from clients before countermeasures are taken to deal with the rogue. The rogue may be able to confuse the client, and perhaps obtain some encrypted data, but the risk is minimal (even less than for some wired networks).

As used herein, hardware components are referred to, for conceptual reasons, as existing “inside” VLANs. It should be noted that switches, instead of being referred to as “in” a VLAN, may be referred to as hosting the VLAN. A switch that does not host a user's VLAN may tunnel to a switch that does host a user's VLAN. Similarly, a user may be referred to as being “on” a VLAN. In the alternative, the user (or the user's station) could be referred to as tunneling to a switch that hosts the user's VLAN.

As used herein, access point (AP) refers to receiving points for any known or convenient wireless access technology. Specifically, the term AP is not intended to be limited to 802.11 APs.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and techniques described herein also relate to apparatus for performing the algorithms and techniques. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system comprising:
a first switch, associated with a first access technology;
an access point (AP) coupled to the first switch;
a second switch, associated with a second access technology, hosting a virtual LAN (VLAN);
a user database, including a user profile that is associated with the VLAN, coupled to the second switch;
wherein, in operation:
a mobile station associated with the user profile associates with the AP;
a VLAN tunnel is formed between the first switch and the second switch;
the user associated with the user profile is provided a persistent Layer 3 identity on the VLAN.

2. The system of claim 1, wherein the first access technology is a wireless access technology other than 802.11 and the second access technology is 802.11.

3. The system of claim 1, wherein the first access technology is 802.11 and the second access technology is a wireless technology other than 802.11.

4. The system of claim 1, wherein the first access technology is a known or convenient wireless access technology and the second access technology is a different known or convenient wireless access technology.

5. The system of claim 1, wherein the AP is a first AP, further comprising:
a second AP coupled to the second switch;
wherein, in operation:
the mobile station roams from the first AP to the second AP;
the user maintains the persistent Layer 3 identity on the VLAN.

6. The system of claim 1, wherein the AP is a first AP and the VLAN tunnel is a first VLAN tunnel, further comprising:
a third switch, associated with a third access technology;
a third AP coupled to the third switch;
wherein, in operation,
the mobile station roams to the third AP;
a second VLAN tunnel is formed between the third switch and the second switch;
the user maintains the persistent Layer 3 identity on the VLAN.

7. The system of claim 6, wherein the first access technology and the third access technology are the same access technology.

8. The system of claim 6, wherein the first access technology and the second access technology are the same access technology.

9. The system of claim 6, wherein the second access technology and the third access technology are the same access technology.

10. The system of claim 1, further comprising:
a Layer 3 network coupled to the first switch and the second switch;
a voice gateway coupled to the Layer 3 network;
wherein, in operation:
the VLAN tunnel carries voice traffic virtually from the first switch to the second switch;
the voice traffic is forwarded through the Layer 3 network between the second switch and the voice gateway;
the user associated with the user profile is provided a persistent Layer 3 identity on the VLAN.

11. The system of claim 1, wherein the mobile station is a 3G handset, and the first switch is a GGSN.

12. The system of claim 1, wherein the mobile station is a 3G handset, and the second switch is a GGSN.

13. A switch comprising:
a control processor;
first memory, having a session management module stored therein, coupled to the control processor;
a forwarding processor coupled to the control processor;
second memory, having a Layer 3 encapsulation module and an Ethernet switch module stored therein, coupled to the forwarding processor;
an Ethernet interface couple to the forwarding processor;
wherein, in operation,
the session management module receives notice that a station with a persistent Layer 3 identity has roamed to an access point coupled to the Ethernet interface;
the session management module determines that the station is associated with a remote VLAN;
the control processor informs the forwarding processor that the station is associated with a remote VLAN;
the Ethernet switch module establishes a VLAN tunnel between the Ethernet interface and a switch hosting the remote VLAN;
the Layer 3 encapsulation module uses the persistent Layer 3 identity of the station to encapsulate Layer 2 data to and from the switch hosting the remote VLAN.

14. The system of claim 13, wherein the switch is associated with a first radio technology and the station is associated with a second radio technology.

15. The system of claim 13, further comprising a portion of a distributed user database, wherein the distributed user database includes data sufficient to associate the station with the remote VLAN.

16. The system of claim 13, wherein the second memory includes a translation module that:
translates a first frame of a first radio technology into a second frame of a second radio technology;
injects the second frame into the Ethernet switch module and the L3 encapsulation module for VLAN tunneling to the switch hosting the remote VLAN.

17. A method comprising:
associating a mobile station with a first switch at a first point of attachment using a first radio technology;
assigning a mobile station to a virtual LAN (VLAN);
providing a Layer 3 identity for the mobile station;
associating the mobile station with a second switch at a second point of attachment using a second radio technology;
detecting the VLAN assignment;
enabling the mobile station to continue to use the Layer 3 identity without disruption.

18. The method of claim 17, further comprising:
using the Layer 3 identity in association with an application;
continuing to use the Layer 3 identity in association with the application when the mobile station roams from the first station to the second station.

19. The method of claim 17, further comprising establishing a VLAN tunnel from the second switch to the first switch on the assigned VLAN.

20. The method of claim 17, further comprising establishing a VLAN tunnel from the second switch to a third switch on the assigned VLAN.
